(19) United States
(12) Patent Application Publication
(10) Pub. No.: US 2026/0343211 A1
(43) Pub. Date: Oct. 29, 2026

(54) COMMUNICATION METHOD AND APPARATUS, USER EQUIPMENT, COMMUNICATION SYSTEM, AND STORAGE MEDIUM

(71) Applicant: Beijing Xiaomi Mobile Software Co., Ltd., Beijing (CN)

(72) Inventor: Jinhua WU, Beijing (CN)

(21) Appl. No.: 19/123,233

(22) PCT Filed: Oct. 27, 2022
(86) PCT No.: PCT/CN2022/128087

§ 371 Date: Apr. 22, 2025

(51) Int. Cl. H04W 8/24; H04L 41/14

(52) U.S. Cl. CPC H04W 8/24; H04L 41/14

(57) ABSTRACT

A communication method includes: sending, to an Access and Mobility Management Function (AMF) by a user equipment, information related to an energy source of the user equipment.

### CROSS-REFERENCE TO RELATED APPLICATIONS

The present application is a U.S. National Stage of International Application No. PCT/CN 2022/128087, filed on Oct. 27, 2022, the disclosure of which is incorporated herein by reference in its entirety.

### TECHNICAL FIELD

The present disclosure relates to the field of communication technology, and in particular to a communication method and apparatus, a user equipment, a communication system and a storage medium.

### BACKGROUND

Ambient power-enabled Internet of Things (ambient IoT) is an IoT that supports ambient power. In certain use cases, IoT devices can be powered by ambient energy. However, due to instability of ambient energy, it is not possible to continuously provide IoT devices with sufficient power through ambient energy to support continuous wireless communication between the IoT devices and mobile networks.

### SUMMARY

According to a first aspect of an embodiment of the present disclosure, a communication method is provided, which is applied to a user equipment, and the method includes:

sending information related to an energy source of the user equipment.

According to a second aspect of an embodiment of the present disclosure, a communication method is provided, which is applied to an AMF, and the method includes:

receiving information related to an energy source of a user equipment;

sending an analytics request; and receiving information related to energy status and/or predication of the user equipment.

According to a third aspect of an embodiment of the present disclosure, a communication method is provided, which is applied to a NWDAF, and the method includes:

receiving an analytics request;

performing analytics in response to the analytics request; and

sending analytics information.

According to a fourth aspect of an embodiment of the present disclosure, a communication method is provided, which is applied to a communication system, and the method includes:

receiving, by an AMF, information related to an energy source of an user equipment from the user equipment;

sending, by the AMF, an analytics request to a NWDAF;

performing, by the NWDAF, analytics in response to the analytics request; and

sending, by the NWDAF, analytics information to the AMF.

According to a fifth aspect of an embodiment of the present disclosure, a communication apparatus is provided, which is applied to a user equipment, and the communication apparatus includes:

an information sending module, configured to send information related to an energy source of the user equipment.

According to a sixth aspect of an embodiment of the present disclosure, a communication apparatus is provided, which is applied to AMF, and the communication apparatus includes:

an information receiving module, configured to receive information related to an energy source of a user equipment;

an analytics request sending module, configured to send an analytics request; and

a status receiving module, configured to receive information related to energy status and/or predication of the user equipment.

According to a seventh aspect of an embodiment of the present disclosure, a communication apparatus is provided, which is applied to NWDAF, and the communication apparatus includes:

an analytics request receiving module, configured to receive an analytics request;

an analytics module, configured to perform analytics according to the analytics request; and

an analytics information sending module, configured to send analytics information.

According to an eighth aspect of an embodiment of the present disclosure, a communication apparatus is provided, which is applied to a communication system, and the communication apparatus includes:

an AMF receiving module, configured for an AMF to receive information related to an energy source of an user equipment from the user equipment;

an AMF sending module, configured for the AMF to send an analytics request to a NWDAF;

a NWDAF analytics module, configured for NWDAF to perform analytics according to the analytics request; and

a NWDAF sending module, configured for the NWDAF to send analytics information to the AMF.

According to a ninth aspect of an embodiment of the present disclosure, a user equipment is provided, including:

a processor;

a memory, configured to store instructions executable by the processor;

where the processor is configured to execute the executable instructions to implement the communication method provided in the first aspect to the fourth aspect of the present disclosure.

According to a tenth aspect of an embodiment of the present disclosure, a communication system is provided, the communication system including:

a AMF, configured to receive information related to an energy source of a user equipment from the user equipment, and send an analytics request to a NWDAF; and

the NWDAF, configured to perform analytics according to the analytics request, and send analytics information to the AMF.

According to an eleventh aspect of an embodiment of the present disclosure, a computer-readable storage medium is provided, on which computer program instructions are stored, where the program instructions, when being executed by a processor, implement steps of the communication method provided in the first to fifth aspects of the present disclosure.

It is to be understood that the foregoing general description and the following detailed description are illustrative and explanatory only and are not restrictive of the present disclosure.

### BRIEF DESCRIPTION OF THE DRAWINGS

The above and/or additional aspects and advantages of the present disclosure will become apparent and easily understood from the following description of the embodiments in conjunction with the accompanying drawings, in which:

FIG. 1 is a flowchart showing a communication method according to some embodiments.

FIG. 2 is a flow chart showing a communication method according to some other embodiments.

FIG. 3 is a flow chart showing a communication method according to yet some other embodiments.

FIG. 4 is a flow chart showing a communication method according to still some other embodiments.

FIG. 5 is a flowchart showing a communication method according to some embodiments.

FIG. 6 is a flowchart showing a communication method according to some other embodiments.

FIG. 7 is a flowchart showing a communication method according to yet some other embodiments.

FIG. 8 is a flowchart showing a communication method according to some embodiments.

FIG. 9 is a flow chart showing a communication method according to some embodiments.

FIG. 10 is a flowchart showing a communication method according to some embodiments.

FIG. 11 is a flow chart showing a communication method according to some embodiments.

FIG. 12 is a schematic diagram showing a communication system according to some embodiments.

FIG. 13 is a schematic diagram showing a communication system according to some embodiments.

FIG. 14 is a schematic diagram showing a communication system according to some embodiments.

FIG. 15 is a schematic diagram showing a communication system according to some embodiments.

FIG. 16 is an illustrative flow chart showing a communication method according to some embodiments.

FIG. 17 is a structural schematic diagram showing a user equipment according to some embodiments.

FIG. 18 is a structural schematic diagram showing a network side device according to some embodiments.

### DETAILED DESCRIPTION

Illustrative embodiments will be described in detail herein. When the following description refers to the drawings, unless otherwise indicated, the same numbers in different drawings represent the same or similar elements. The implementations described in the following illustrative embodiments do not represent all implementations consistent with the present disclosure. Instead, they are merely examples of devices and methods consistent with some aspects of the present disclosure as detailed in the appended claims.

The user equipment (UE) involved in the present disclosure is an ambient power-enabled Internet of Things device (ambient IoT device). The user equipment is, for example, a mobile station, a tablet computer, etc. that can utilize ambient energy, or a mobile terminal, a fixed terminal, etc. in various fields that can utilize ambient energy. The specific form of the user equipment is not limited in the present disclosure.

The first network side device involved in the present disclosure is, for example, an access and mobility management function (AMF), but may also be other entities that can perform management.

The second network side device involved in the present disclosure is, for example, a network data analytics function (NWDAF), but may also be other entities that can perform analytics.

For the ambient IoT device that uses solar energy, the device can perform normal communication during sunny days, but on rainy days or at night, it may have to use stored power and may have to be in a dormant state in which it only receives signaling/data or does not send or receive signaling/data. The ambient IoT devices that use other ambient energy sources also have similar situations. Therefore, the ambient IoT devices may not have continuous energy to deal with always-on communication or on-demand communication.

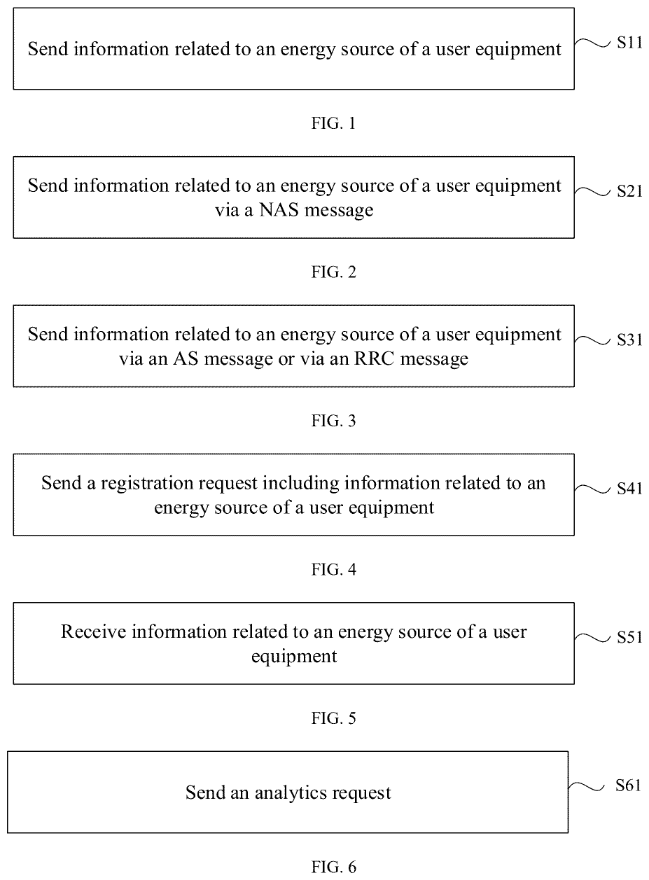

FIG. 1 is a flow chart of a communication method for a user equipment according to an embodiment of the present disclosure. As shown in FIG. 1, the communication method includes the following steps.

In step S11, information related to an energy source of the user equipment is sent.

In the embodiment of the present disclosure, the energy source of the user equipment may be at least one of solar energy, light energy, wind energy, motion/vibration energy, heat energy, and pressure energy, or may be any other energy source. In addition, the information related to the energy source of the user equipment may be referred to as energy source information.

The information related to the energy source of the user equipment is, for example, a power source indication. The energy source indication may be at least one of solar energy, light energy, wind energy, motion energy, vibration energy, heat energy, and pressure energy.

As a specific implementation, the user equipment may send the information related to the energy source of the user equipment to a first network side device. Optionally, the user equipment may send the information related to the energy source to the first network side device in response to an information sending request.

The embodiment of the present disclosure discloses that the user equipment can send the energy source information to the first network side device, so that the information related to the energy source can be used to better support ambient Internet of Things communications and effectively deal with always-on communications or on-demand communications.

In an embodiment, the user equipment may send the information related to the energy source of the user equipment to the first network side device through a Radio Access Network (RAN). The RAN may also be replaced by an Access Network (AN), or a combination of the RAN and the AN. The sending through the RAN may be, for example, sending through a network side device such as a gNB, which is described in detail below.

FIG. 2 is a flow chart of another communication method for a user equipment according to an embodiment of the present disclosure. As shown in FIG. 2, the communication method includes the following steps.

In step S21, information related to an energy source of the user equipment is sent via a NAS message.

Sending through a Non-access stratum (NAS) message is transparent sending, that is, it is sent directly without checking the content.

The embodiments of the present disclosure may be combined with other embodiments or implementations relevant to the communication methods for user equipment and various optional solutions thereof if there is no contradiction. Reference can be made to the above introduction, which will not be repeated here.

The embodiment of the present disclosure discloses that the user equipment can send the information related to the energy source of the user equipment via the NAS message, so that the information related to the energy source can be used to better support ambient Internet of Things communications and effectively deal with always-on communications or on-demand communications.

FIG. 3 is a flow chart of another communication method for a user equipment according to an embodiment of the present disclosure. As shown in FIG. 3, the communication method includes the following steps.

In step S31, information related to an energy source of the user equipment is sent via an AS message or via an RRC message.

The information related to the energy source of the user equipment is sent through an Access stratum (AS) message or a Radio Resource Control (RRC) message. For example, the information is sent after being parsed.

In an embodiment of the present disclosure, the user equipment may send the information related to the energy source of the user equipment through the AS message. As a specific implementation, the user equipment may send the information related to the energy source of the user equipment to the RAN via the AS message. In an embodiment of the present disclosure, the user equipment may also send the information related to the energy source of the user equipment via the RRC message. As a specific implementation, the user equipment may send the information related to the energy source of the user equipment to the RAN via the RRC message. The RAN may send the information related to the energy source of the user equipment to the first network side device via an N2 message.

The embodiments of the present disclosure may be combined with other embodiments or implementations relevant to the communication methods for user equipment and various optional solutions thereof if there is no contradiction. Reference can be made to the above introduction, which will not be repeated here.

The embodiment of the present disclosure discloses that the user equipment can send the information related to the energy source of the user equipment via the AS message or via RRC, so that the information related to the energy source can be used to better support ambient Internet of Things communications and effectively deal with always-on communications or on-demand communications.

FIG. 4 is a flow chart of another communication method for a user equipment according to an embodiment of the present disclosure. As shown in FIG. 4, the communication method includes the following steps.

In step S41, a registration request including information related to an energy source of the user equipment is sent.

The registration request is, for example, a Registration request, which may be used for authentication and/or authorization of the user equipment.

For example, the user equipment may send the registration request to the first network side device for registration, and the registration request includes information related to the energy source of the user equipment. The user equipment may, for example, receive a registration accept message after sending the registration request including the information related to the energy source of the user equipment. The registration accept message is, for example, Registration Accept.

The registration request may include, for example, at least one of a registration type, SUCI, 5G-GUTI, PEI, security parameters, etc. The registration accept message may include, for example, 5G-GUTI.

The embodiments of the present disclosure may be combined with other embodiments or implementations relevant to the communication methods for user equipment and various optional solutions thereof if there is no contradiction. Reference can be made to the above introduction, which will not be repeated here.

The embodiment of the present disclosure discloses that the user equipment sends the information related to the energy source of the user equipment through the registration request, so that the information related to the energy source can be used to better support the ambient Internet of Things communication, and effectively deal with always-on communication or on-demand communication. In addition, in the present disclosure, the information related to the energy source of the user equipment is sent by sending the registration request, thereby ensuring that additional signaling overhead can be reduced.

FIG. 5 is a flow chart of a communication method for a first network side device according to an embodiment of the present disclosure. As shown in FIG. 5, the communication method includes the following steps.

In step S51, information related to an energy source of a user equipment is received.

Optionally, the first network side device may send a reception confirmation to the user equipment after receiving the information related to the energy source of the user equipment.

In the embodiment of the present disclosure, the energy source of the user equipment may be at least one of solar energy, light energy, wind energy, motion/vibration energy, heat energy and pressure energy, or may be any other energy source. In addition, the information related to the energy source of the user equipment may be referred to as energy source information.

The information related to the energy source of the user equipment is, for example, an energy source indication. The energy source indication may be at least one of solar energy, light energy, wind energy, motion energy, vibration energy, heat energy, and pressure energy.

In an embodiment, the first network side device may receive information related to the energy source of the user equipment through the RAN. Receiving through the RAN may be, for example, receiving through a network side device such as a gNB.

In the embodiment of the present disclosure, the first network side device may receive the information related to the energy source of the user equipment from the user equipment. Optionally, the first network side device may receive the information related to the energy source of the user equipment via a NAS message, or may receive the information related to the energy source of the user equipment via an AS message or via an RRC message.

In an embodiment, the first network side device may receive a registration request including the information related to the energy source of the user equipment.

The registration request is, for example, a Registration request, which can be used for authentication and/or authorization of the user equipment. Optionally, the first network side device can send a registration accept message to the user equipment. The registration accept message is, for example, Registration Accept. The registration accept message can include, for example, 5G-GUTI.

The first network side device may store the information related to the energy source of the user equipment, for example, by means of a UE context.

Optionally, the first network side device may send the information related to the energy source of the user equipment to the RAN through an N2 message, and the RAN stores the information by means of a UE context.

The embodiment of the present disclosure discloses that the first network side device receives the information related to the energy source of the user equipment, so that it can better support ambient Internet of Things communications and effectively deal with always-on communications or on-demand communications.

FIG. 6 shows another communication method for a first network side device according to an embodiment of the present disclosure. As shown in FIG. 6, the communication method includes the following steps.

In step S61, an analytics request is sent.

The analytics request is used to request the network side device to send analytics information. The analytics request is, for example, Analytics request. In an implementation, the analytics request is sent to obtain energy status of the user equipment. The analytics request may include the energy source and/or location information of the user equipment. The location information is, for example, a cell ID. The analytics information is, for example, information related to the energy status and/or predication of the user equipment.

As a specific implementation, the first network side device may send the analytics request to a second network side device. Optionally, the first network side device may receive analytics information from the second network side device so as to manage the communication of the user equipment using the analytics information. The analytics information includes, for example, the energy status of the user equipment.

Optionally, the first network side device may request the analytics information by invoking Nnwdaf_AnalyticsInfo_Request service operation.

The embodiments of the present disclosure may be combined with other embodiments or implementations relevant to the communication methods for the first network side device and various optional solutions thereof if there is no contradiction. Reference can be made to the above introduction, which will not be repeated here.

The embodiment of the present disclosure discloses that the first network side device sends the analytics request, so that it can better support ambient Internet of Things communications and effectively deal with always-on communications or on-demand communications.

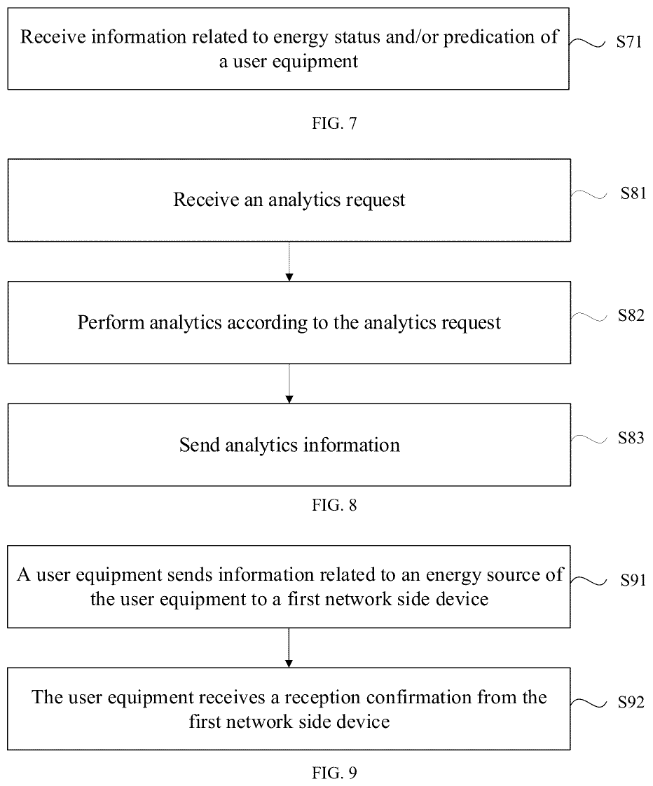

FIG. 7 shows another communication method for a first network side device according to an embodiment of the present disclosure. As shown in FIG. 7, the communication method includes the following steps.

In step S71, information related to energy status and/or predication of a user equipment is received.

The information related to energy status and/or predication of the user equipment may be received after the analytics request is sent, or may be received without sending the analytics request.

The analytics request is used to request the network side device to send analytics information. The analytics request is, for example, Analytics request. In an implementation, the analytics request is sent to obtain the energy status of the user equipment. The analytics request may include the energy source and/or location information of the user equipment. The location information is, for example, a cell ID. The analytics information is, for example, information related to the energy status and/or predication of the user equipment.

The energy status of the user equipment includes, for example, an ordinary energy mode, a low energy mode, and a no energy mode. In the ordinary energy mode, the first network side device and other core network nodes can receive or send signaling and/or data from or to the user equipment. In the low energy mode, the first network side device and other core network nodes only send signaling and/or data to the user equipment, and cannot receive signaling and/or data from the user equipment. In the no energy mode, the first network side device and other core network nodes do not send signaling and/or data to the user equipment, nor do they receive signaling and/or data from the user equipment. The classification method is not limited to this, and the above modes may be partially combined or further divided.

After receiving the information related to the energy status and/or predication of the user equipment, the first network side device may also store the information and perform processing corresponding to the information.

In an embodiment, after receiving the information related to the energy source of the user equipment, the first network side device may send the information related to the energy status and/or predication of the user equipment to the RAN (for example, through an N2 message). The RAN may store this information and perform processing corresponding to the information. For the processing for different energy status, reference may be made to the relevant contents stated above.

The embodiments of the present disclosure may be combined with other embodiments or implementations relevant to the communication methods for the first network side device and various optional solutions thereof if there is no contradiction. Reference can be made to the above introduction, which will not be repeated here.

The embodiment of the present disclosure discloses that the first network side device receives the information related to energy status and/or predication of the user equipment, so that it can better support ambient Internet of Things communications and effectively deal with always-on communications or on-demand communications.

FIG. 8 shows a communication method for a second network side device according to an embodiment of the present disclosure. As shown in FIG. 8, the communication method includes the following steps.

In step S81, an analytics request is received.

In step S82, analytics is performed according to the analytics request.

In step S83, analytics information is sent.

The analytics request is used to request the network side device to send analytics information. The analytics request is, for example, Analytics request. The analytics request may include the energy source and/or location information of the user equipment. The location information is, for example, a cell ID. The analytics information is, for example, information related to the energy status and/or predication of the user equipment.

Performing the analytics according to the analytics request may include that the second network side device performs the analytics by itself, or performs the analytics with the help of other subjects. Whether the second network side device performs the analytics by itself or with the help of other subjects may be determined in advance or may be determined by the second network side device or the other subjects.

The second network side device performing analytics by itself is, for example, that the second network side device performs the analytics using relevant information. The performing analytics with the help of other subjects is, for example, that the second network side device requests relevant information from an application function (AF) via a network exposure function (NEF) and performs the analytics. For example, the second network side device can subscribe to data in the AF via the NEF by invoking Nnef_EventExposure_Subscribe service operation.

For user equipment using solar energy, the relevant information is, for example, weather status and/or weather predication, and specifically, is sunny, rainy, cloudy, snowy, etc. Optionally, the relevant information may come from a meteorological department and/or an application.

In an implementation, based on the location of the user equipment in the analytics request, the second network side device can obtain the relevant information related to the location. For example, the city or other geographical information can be determined according to the cell ID, and the relevant information can be determined according to the city or other geographical information.

Optionally, the subscription to the AF may be authorized by the NEF, and in this case, the association between an event trigger and an identity of the second network side device is recorded by the NEF. Optionally, the NEF may subscribe to the data in the AF by invoking Naf_EventExposure_Subscribe service operation according to the request from the second network side device. Optionally, if the NEF subscribes to the data in the AF, the AF the notifies NEF of the data by invoking Naf_EventExposure_Notify service operation.

In the present disclosure, the communication method for the user equipment, the communication method for the first network side device, and the communication method for the second network side device can be combined with each other if there is no contradiction, and the order of the steps can also be changed if there is no contradiction.

FIG. 9 is a flow chart of a communication method according to an embodiment of the present disclosure. As shown in FIG. 9, the communication method includes the following steps.

In step S91, a user equipment sends information related to an energy source of the user equipment to a first network side device.

In step S92, the user equipment receives a reception confirmation from the first network side device.

The information related to the energy source of the user equipment is sent, for example, through a registration request, and the reception confirmation is sent, for example, through a registration accept message.

The embodiment of the present disclosure may be combined with other embodiments or implementations relevant to the communication methods for the user equipment and the communication methods for the first network side device, and various optional solutions thereof if there is no contradiction, and the repeated description is omitted here.

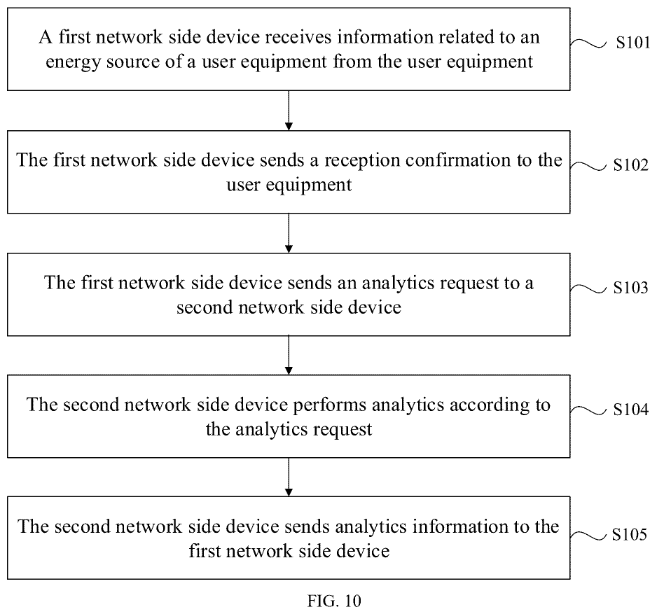

FIG. 10 is a flow chart of a communication method according to an embodiment of the present disclosure. As shown in FIG. 10, the communication method includes the following steps.

In step S101, a first network side device receives information related to an energy source of a user equipment from the user equipment.

In step S102, the first network side device sends a reception confirmation to the user equipment.

In step S103, the first network side device sends an analytics request to a second network side device.

In step S104, the second network side device performs analytics according to the analytics request.

In step S105, the second network side device sends analytics information to the first network side device.

The embodiment of the present disclosure can be combined with the embodiments or implementations relevant to the communication method for the user equipment, the communication method for the first network side device, and the communication method for the second network side device, and the various optional solutions thereof if there is no contradiction, and the repeated description is omitted here.

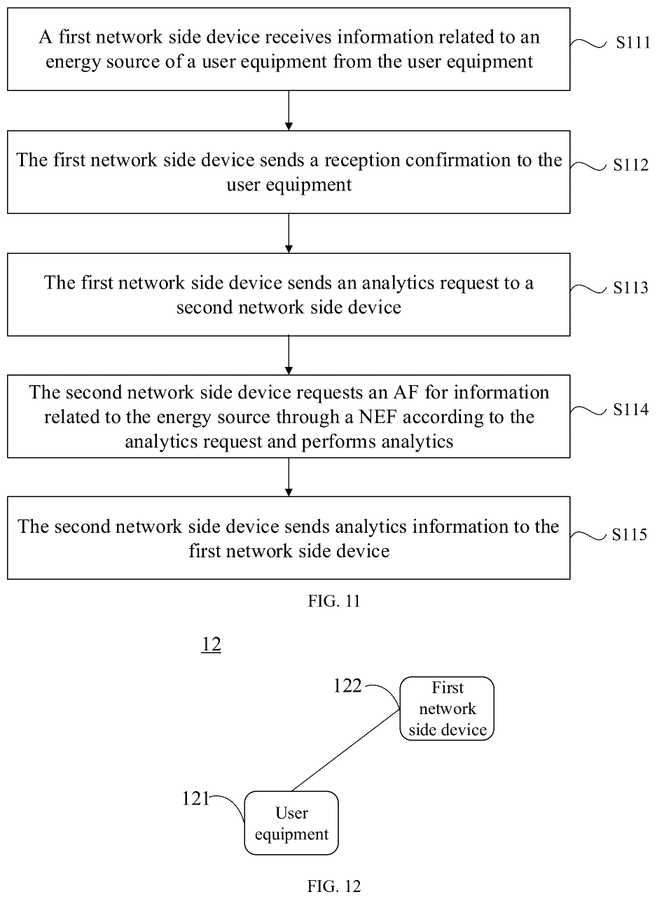

FIG. 11 is a flow chart of a communication method according to an embodiment of the present disclosure. As shown in FIG. 11, the communication method includes the following steps.

In step S111, a first network side device receives information related to an energy source of a user equipment from the user equipment.

In step S112, the first network side device sends a reception confirmation to the user equipment.

In step S113, the first network side device sends an analytics request to a second network side device.

In step S114, the second network side device requests an AF for information related to the energy source through a NEF according to the analytics request and performs analytics.

In step S115, the second network side device sends analytics information to the first network side device.

The embodiment of the present disclosure can be combined with the embodiments or implementations relevant to the communication method for the user equipment, the communication method for the first network side device, and the communication method for the second network side device and the various optional solutions thereof if there is no contradiction, and the repeated description is omitted here.

FIG. 12 is a schematic diagram of a communication system according to an embodiment of the present disclosure.

The communication system 12 includes a user equipment 121 and a first network side device 122.

For actions performed by the user equipment 121 and the first network side device 122, reference can be made to FIG. 9 and the embodiments corresponding thereto.

The embodiment of the present disclosure may be combined with the embodiments or implementations relevant to the communication method for the user equipment and the communication method for the first network side device and various optional solutions thereof if there is no contradiction, and the repeated description is omitted here.

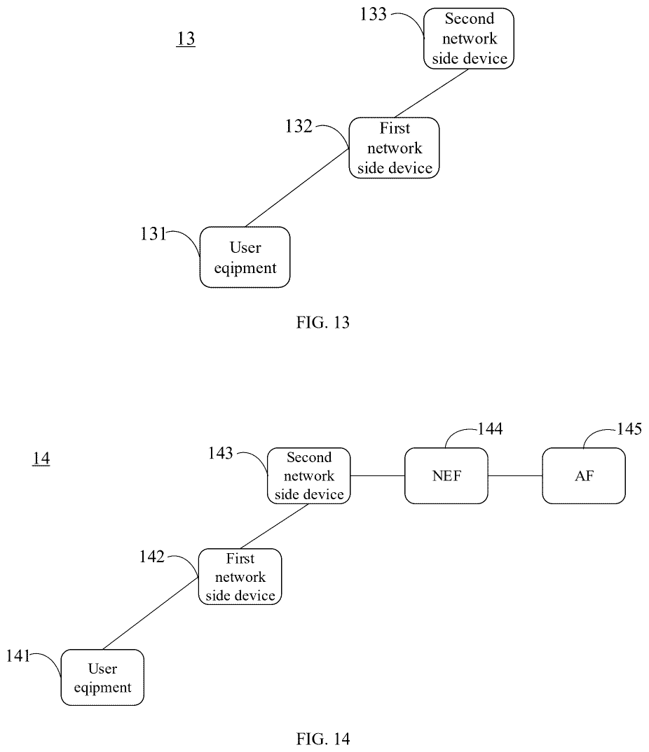

FIG. 13 is a schematic diagram of a communication system according to an embodiment of the present disclosure.

The communication system 13 includes a first network side device 132 and a second network side device 133.

For actions performed by the first network side device 132 and the second network side device 133, reference can be made to FIG. 10 and the embodiments corresponding thereto.

The embodiment of the present disclosure may be combined with the embodiments or implementations relevant to the communication method for the first network side device and the communication method for the second network side device and various optional solutions thereof if there is no contradiction, and the repeated description is omitted here.

FIG. 14 is a schematic diagram of a communication system according to an embodiment of the present disclosure.

The communication system 14 includes a user equipment 141, a first network side device 142, a second network side device 143, an NEF 144, and an AF 145.

For actions performed by the user equipment 141, the first network side device 142, the second network side device 143, the NEF 144, and the AF 145, reference can be made to FIG. 11 and the embodiments corresponding thereto.

The embodiments of the present disclosure can be combined with the embodiments or implementations relevant to the communication method for the user equipment, the communication method for the first network side device, and the communication method for the second network side device, and various optional solutions thereof if there is no contradiction, and the repeated description is omitted here.

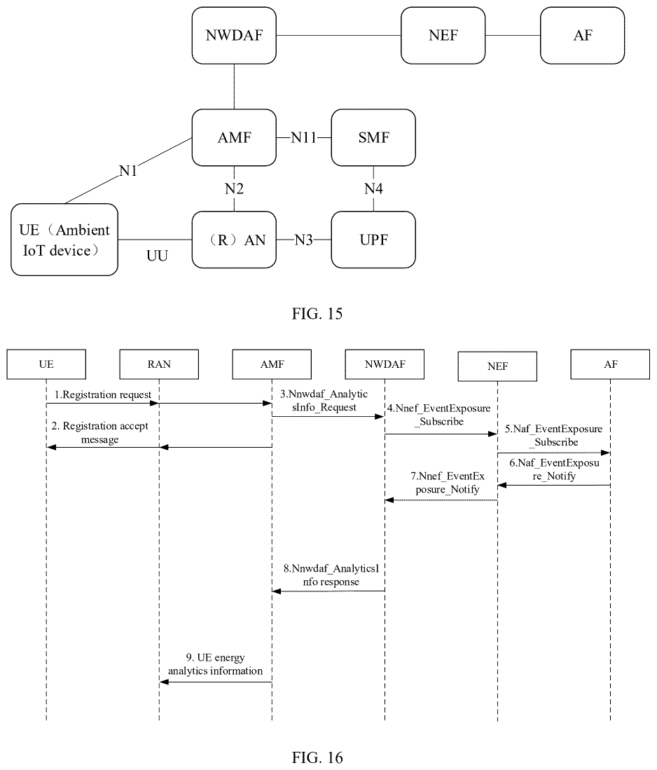

FIG. 15 is an illustrative schematic diagram of a communication system according to an embodiment of the present disclosure.

FIG. 16 is an illustrative flow chart of a communication method according to an embodiment of the present disclosure.

As shown in FIG. 15 and FIG. 16, an example of a specific solution of the present disclosure is as follows.

1. The UE sends a registration request to an AMF via a RAN (for example, a gNB). The registration request may include parameters: energy source indication, a registration type, SUCI, G-GUTI, a PEI identity, security parameters, etc. The energy source indication may be solar, light, motion/vibration, heat, pressure, etc. Optionally, the UE may send the energy source indication to the RAN through an RRC message, and then the RAN may send the energy source indication to the AMF through an N2 message.

2. After authentication and authorization of the UE, the AMF sends a registration accept message (Registration Accept) to the UE to complete the registration, where the registration accept message may include the 5G-GUTI. The AMF may store the energy source of the UE in the UE context in the AMF. Optionally, the AMF may send the energy source to the RAN via an N2 message, and then the RAN may store the energy source of the UE in the UE context in the RAN.

3. The AMF can request analytics information by invoking Nnwdaf_AnalyticsInfo_Request service operation. The parameters provided by the AMF may include the energy source (solar) and location of UE (e.g., cell identity). When receiving the analytics request, a NWDAF determines whether triggering new data collection to the AF is needed.

4. The NWDAF subscribes to the data in the AF by invoking Nnef_EventExposure_Subscribe service operation through NEF. These data may be weather status and predication (sunny, rainy, cloudy, snowy, etc.) in the UE's location from the meteorological department/application. The UE's location can be mapped from the cell identity to the city/geographic location information by the NWDAF. If the event subscription is authorized by the NEF, the NEF records the association between the event trigger and the NWDAF identity.

5. Based on the request from the NWDAF, the NEF subscribes to the data in the AF by invoking Naf_EventExposure_Subscribe service operation.

6. If the NEF subscribes to the data, the AF notifies the NEF of the data by invoking the Naf_EventExposure_Notify service operation according to event report information in the subscription in steps 4 and 5.

7. If the NEF receives notification from the AF, the NEF can notify the NWDAF of the data by invoking Nnef_EventExposure_Notify service operation.

8. Based on the data received from the AF (e.g., weather status and predication in the UE's location), the NWDAF can generate analytics information and respond to the AMF with information about the UE energy status and f predication: energy status mode (ordinary, low energy, or no energy) for the current or future time. The AMF can store the received UE energy status mode and correspondingly treat the communication.

For the ordinary energy status mode, the communication is ordinary, and the AMF and other core network nodes can send/receive signaling and data to/from the UE.

For the low energy status mode, the communication is only for the UE as a receiver, and the AMF and other core network nodes only send signaling and data to the UE.

For the no energy status mode, the communication is stopped and the AMF and other core network nodes do not send/receive signaling and data to/from the UE.

9. The AMF sends the analytics information to the serving RAN of the UE via a N2 message. The RAN may store the received analytics information and correspondingly treat the communication.

For example, for the ordinary energy status mode, the communication is ordinary, and the RAN can send signaling and data to the UE, or receive signaling and data from the UE.

For the low energy status mode, the communication is only for the UE as a receiver, the RAN only sends signaling and data to the UE, and the signaling and data may be from a core network or the RAN.

In the no energy status mode, the communication is stopped and the RAN does not send/receive signaling and data to/from the UE.

In the embodiments of the present disclosure, the mobile network can support ambient IoT communications, although the ambient IoT devices may not have continuous power for always-on or on-demand communications. The NWDAF can generate energy status information of the UE based on the energy source and location of the UE. In the present disclosure, new parameters (energy status mode: ordinary, low energy, no energy) and corresponding operations are introduced in the core network and RAN.

As an example, in the present disclosure, the ambient IoT device may report the energy source to the AMF through a NAS message, or may report the energy source to the RAN through an AS message (RRC).

As an example, in the present disclosure, the AMF may receive and store the energy source of the ambient IoT device from the ambient IoT device through a NAS message. The AMF may send an analytics request to the NWDAF to obtain the energy status of the ambient IoT device, and the analytics request may include the energy source and location of the ambient IoT device. The AMF may store the analytics information from the NWDAF and may use the analytics information for the management of the communication of the ambient IoT device.

As an example, in the present disclosure, the RAN may receive and store the energy source of the ambient IoT device from the ambient IoT device through an RRC message, or may receive the energy source of the ambient IoT device from the AMF through an N2 message. The AMF may receive the energy status and predication of the ambient IoT device from the AMF through an N2 message and use them.

As an example, in the present disclosure, the NWDAF can perform analysis and prediction of the energy status of the e ambient IoT device based on the analytics request of the ambient IoT device received from AMF, and return the analytics information to AMF. In order to perform the analytics, the NWDAF can request additional data/information from the AF through the NEF. For example, for a solar power enabled IoT device, the NWDAF can request weather status and predication (sunny, rainy, cloudy, snowy, etc.) from the meteorological department/application (e.g., the AF).

As an example, the AF can provide information to the NWDAF via the NEF upon request. For example, a meteorological department/application can provide weather status and predication (sunny, rainy, cloudy, snowy, etc.).

The above examples can be applied to all embodiments of the methods, apparatus, devices, storage media, systems, etc. described in the present disclosure, which will not be repeated here.

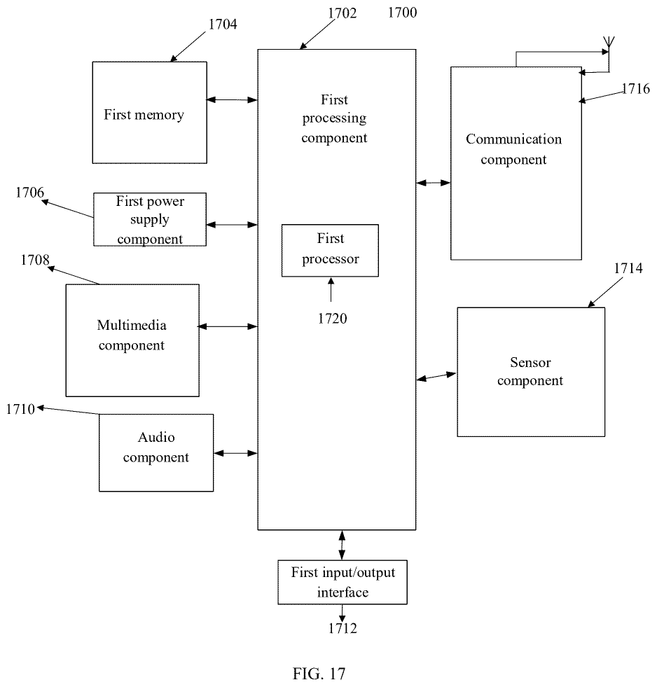

FIG. 17 is a block diagram of a user equipment according to some embodiments. In the embodiment of the present disclosure, the user equipment may be an ambient power enabled IoT device. For example, the user equipment 1700 may be a solar cell, a street lamp, a mobile phone, a computer, a digital broadcast terminal, a messaging device, a game console, a tablet device, a medical device, a fitness device, a personal digital assistant, a smart car, etc.

Referring to FIG. 17, the user equipment 1700 may include one or more of the following components: a first processing component 1702, a first memory 1704, a first power supply component 1706, a multimedia component 1708, an audio component 1710, a first input/output interface 1712, a sensor component 1714, and a communication component 1716.

The first processing component 1702 generally controls the overall operation of the user equipment 1700, such as operations associated with display, phone calls, data communications, camera operations, and recording operations. The first processing component 1702 may include one or more first processors 1720 to execute instructions to complete all or part of the steps of the above communication method. In addition, the first processing component 1702 may include one or more modules to facilitate the interaction between the first processing component 1702 and other components. For example, the first processing component 1702 may include a multimedia module to facilitate the interaction between the multimedia component 1708 and the first processing component 1702.

The first memory 1704 is configured to store various types of data to support operations on the user equipment 1700. Examples of such data include instructions for any application or method operating on the user equipment 1700, contact data, phone book data, messages, pictures, videos, etc. The first memory 1704 can be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The first power supply component 1706 provides power to various components of the user equipment 1700. The first power supply component 1706 may include a power management system, one or more power supplies, and other components associated with generating, managing, and distributing power to the user equipment 1700.

The multimedia component 1708 includes a screen that provides an output interface between the user equipment 1700 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, slide, and gestures on the touch panel. The touch sensor may not only sense the boundaries of the touch or slide action, but also detect the duration and pressure associated with the touch or slide operation. In some embodiments, the multimedia component 1708 includes a front camera and/or a rear camera. When the user equipment 1700 is in an operating mode, such as a shooting mode or a video mode, the front camera and/or the rear camera may receive external multimedia data. The front camera and rear camera each may be a fixed optical lens system or have a focal length and optical zoom capability.

The audio component 1710 is configured to output and/or input audio signals. For example, the audio component 1710 includes a microphone (MIC), and when the user equipment 1700 is in an operation mode, such as a call mode, a recording mode, and a speech recognition mode, the microphone is configured to receive an external audio signal. The received audio signal can be further stored in the first memory 1704 or sent via the communication component 1716. In some embodiments, the audio component 1710 also includes a speaker for outputting audio signals.

The first input/output interface 1712 provides an interface between the first processing component 1702 and a peripheral interface module, which may be a keyboard, a click wheel, buttons, etc. The buttons may include but are not limited to: a home button, a volume button, a start button, and a lock button.

The sensor component 1714 includes one or more sensors for providing various aspects of status assessment for the user equipment 1700. For example, the sensor component 1714 can detect the open/closed state of the user equipment 1700, the relative positioning of components, such as the display and keypad of the user equipment 1700, and the sensor component 1714 can also detect the position change of the user equipment 1700 or a component of the user equipment 1700, the presence or absence of contact between the user and the user equipment 1700, the orientation or acceleration/deceleration of the user equipment 1700, and the temperature change of the user equipment 1700. The sensor component 1714 may include a proximity sensor configured to detect the presence of a nearby object without any physical contact. The sensor component 1714 may also include an optical sensor, such as a CMOS or CCD image sensor, for use in imaging applications. In some embodiments, the sensor component 1714 may also include an accelerometer, a gyroscope sensor, a magnetic sensor, a pressure sensor, or a temperature sensor.

The communication component 1716 is configured to facilitate wired or wireless communication between the user equipment 1700 and other devices. The user equipment 1700 can access a wireless network based on a communication standard, such as Wi-Fi, 2G or 3G, or a combination thereof. In an illustrative embodiment, the communication component 1716 receives a broadcast signal or broadcast related information from an external broadcast management system via a broadcast channel. In an illustrative embodiment, the communication component 1716 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an illustrative embodiment, the user equipment 1700 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above communication methods.

In an illustrative embodiment, a non-transitory computer-readable storage medium including instructions is also provided, such as a first memory 1704 including instructions, and the instructions can be executed by a first processor 1720 of the user equipment 1700 to complete the above communication method. For example, the non-transitory computer-readable storage medium can be a ROM, a random access memory (RAM), a CD-ROM, a magnetic tape, a floppy disk, an optical data storage device, etc.

In addition to being an independent electronic device, the above apparatus can also be a part of an independent electronic device. For example, in an embodiment, the apparatus can be an integrated circuit (IC) or a chip, the integrated circuit can be an IC or a collection of multiple ICs; the chip can include but is not limited to the following types: a Graphics Processing Unit (GPU), a Central Processing Unit CPU (CPU), a Field Programmable Gate Array (FPGA), a Digital Signal Processor (DSP), a Application Specific Integrated Circuit (ASIC), a System on Chip (SoC, an on-chip system or a system-level chip), etc. The above integrated circuit or chip can be used to execute executable instructions (or codes) to implement the above communication method. The executable instructions can be stored in the integrated circuit or chip, or can be obtained from other apparatus or devices. For example, the integrated circuit or chip includes a processor, a memory, and an interface for communicating with other apparatus. The executable instructions may be stored in the memory, and when the executable instructions are executed by the processor, the above communication methods are implemented; alternatively, the integrated circuit or chip may receive the executable instructions through the interface and transmit them to the processor for execution, so as to implement the above communication methods.

In another illustrative embodiment, a computer program product is also provided. The computer program product includes a computer program executable by a programmable apparatus, and the computer program has a code portion for implementing the above communication methods when being executed by the programmable apparatus.

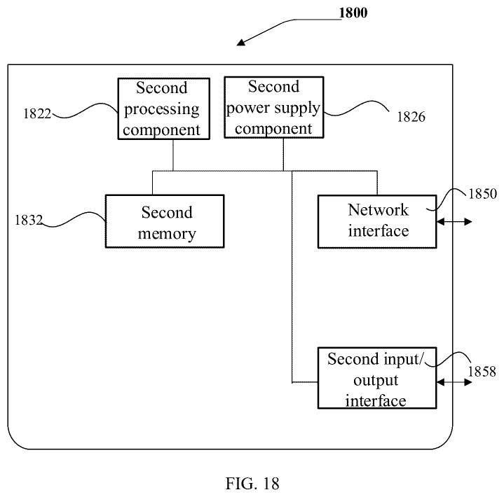

FIG. 18 is a block diagram of a network side device according to an illustrative embodiment, and the network side device may be the RAN, AMF, NWDAF, NEF, AF, SMF, UPF, or the like as described above. For example, the network side device 1800 may be provided as a server. Referring to FIG. 18, the network side device 1800 includes a second processing component 1822, which further includes one or more processors, and a memory resource represented by a second memory 1832, which is configured to store instructions executable by the second processing component 1822, such as an application. The application stored in the second memory 1832 may include one or more modules, each of which corresponds to a set of instructions. In addition, the second processing component 1822 is configured to execute instructions to perform the communication method.

The network side device 1800 may further include a second power supply component 1826 configured to perform power management for the network side device 1800, a wired or wireless network interface 1850 configured to connect the network side device 1800 to a network, and a second input/output interface 1858. The network side device 1800 may operate based on an operating system stored in the memory 1832, such as Windows Server™, Mac OS X™, Unix™, Linux™, FreeBSD™ or the like.

Those skilled in the art will readily appreciate other embodiments of the present disclosure after considering the specification and practicing the present disclosure. The present disclosure is intended to cover any variations, uses or adaptations of the present disclosure, which follow the general principles of the present disclosure and include common knowledge or customary technical means in the art that are not disclosed in the present disclosure. The specification and examples are to be considered as illustrative only, and the true scope and spirit of the present disclosure are indicated by the following claims.

It should be understood that the present disclosure is not limited to the exact structures that have been described above and shown in the drawings, and that various modifications and changes may be made without departing from the scope thereof. The scope of the present disclosure is limited only by the appended claims.

1. A communication method, comprising:
sending, to an Access and Mobility Management Function (AMF) by a user equipment, information related to an energy source of the user equipment.

2. The communication method according to claim 1,
wherein the information related to the energy source of the user equipment is sent via a Non-Access Stratum (NAS) message.

3. The communication method according to claim 1,
wherein the information related to the energy source of the user equipment is sent via an Access Stratum (AS) message or via a Radio Resource Control (RRC) message.

4. The communication method according to claim 1, further comprising:
after sending the information related to the energy source of the user equipment, receiving, by the user equipment, a reception confirmation from the AMF.

5. The communication method according to claim 1, further comprising:
sending, by the user equipment, a registration request, wherein the registration request comprises the information related to the energy source of the user equipment.

6. (canceled)

7. A communication method, applied to a Network Data Analytics Function (NWDAF), the method comprising:
receiving an analytics request;
performing analytics according to the analytics request; and
sending analytics information.

8. The communication method according to claim 7,
wherein in performing analytics according to the analytics request, information related to the energy source is requested from an Application Function (AF) via a Network Exposure Function (NEF) according to the analytics request.

9. (canceled)

10. (canceled)

11. A communication apparatus, comprising:
a processor; and
a memory storing instructions executable by the processor,
wherein the processor is configured to:
send, to an Access and Mobility Management Function (AMF), information related to an energy source of a user equipment.

12. (canceled)

13. A communication apparatus, applied to a Network Data Analytics Function (NWDAF), the apparatus comprising:
a processor; and
a memory storing instructions executable by the processor,
wherein the processor is configured to perform the communication method according to claim 7.

14.-17. (canceled)

18. A non-transitory computer storage medium storing computer executable instructions that, when executed by a processor, cause the processor to perform the communication method according to claim 1.

19. The communication method according to claim 1, further comprising:
receiving, by the AMF, the information related to the energy source of the user equipment from the user equipment;
sending, by the AMF, an analytics request to a Network Data Analytics Function (NWDAF); and
receiving, by the AMF, analytics information from the NWDAF.

20. The communication method according to claim 19, further comprising:
performing, by the NWDAF, analytics according to the analytics request; and
sending, by the NWDAF, the analytics information to the AMF.

21. The communication method according to claim 20,
wherein in performing the analytics according to the analytics request, the NWDAF requests an Application Function (AF) for information related to the energy source through a Network Exposure Function (NEF) according to the analytics request.

22. The communication method according to claim 19, wherein the analytics information is information related to at least one of energy status or energy predication of the user equipment.

23. The communication apparatus according to claim 11,
wherein the information related to the energy source of the user equipment is sent via a Non-Access Stratum (NAS) message.

24. The communication apparatus according to claim 11,
wherein the information related to the energy source of the user equipment is sent via an Access Stratum (AS) message or via a Radio Resource Control (RRC) message.

25. The communication apparatus according to claim 11, wherein the processor is further configured to:
after sending the information related to the energy source of the user equipment, receive a reception confirmation from the AMF.

26. The communication apparatus according to claim 11, wherein the processor is further configured to:
send a registration request, wherein the registration request comprises the information related to the energy source of the user equipment.

27. A non-transitory computer-readable storage medium storing computer executable instructions that, when executed by a processor, cause the processor to perform the communication method according to claim 7.
